(19) United States
(12) Patent Application Publication
(10) Pub. No.: US 2026/0154021 A1
(43) Pub. Date: Jun. 4, 2026

(54) IMAGE FORMING APPARATUS, NON-TRANSITORY COMPUTER-READABLE STORAGE MEDIUM STORING CONTROL PROGRAM THEREOF, AND CONTROL METHOD IMPLEMENTED BY IMAGE FORMING APPARATUS

(71) Applicant: Hiroyuki Kato, Mishima Shizuoka (JP)

(72) Inventor: Hiroyuki Kato, Mishima Shizuoka (JP)

(73) Assignee: ETRIA CO., LTD., Kanagawa (JP)

(21) Appl. No.: 19/272,155

(22) Filed: Jul. 17, 2025

(30) Foreign Application Priority Data
Dec. 3, 2024 (JP) 2024-210717

(51) Int. Cl. G06F 3/12

(52) U.S. Cl. CPC G06F 3/128; G06F 3/1204; G06F 3/1238; G06F 3/1247; G06F 3/1288

(57) ABSTRACT

An image forming apparatus according to an embodiment includes a storage device and a processor. The storage device stores a direct print app that executes the direct print function, and a conversion app that uses a file format conversion function that a cloud server provides. The processor is configured to execute the direct print app to provide to a user a selection environment for selecting a print target file from the files in the external device. The processor is configured to execute the conversion app to request the cloud server to execute file format conversion for converting a file format of the print target file selected through the selection environment into an applicable file format to which the direct print function is applicable, receive a post-conversion file after the file format conversion from the cloud server, and print the post-conversion file.

### CROSS-REFERENCE TO RELATED APPLICATION

This application is based upon and claims the benefit of priority from prior Japanese Patent Application No. 2024-210717, filed Dec. 3, 2024, the entire contents of which are incorporated herein by reference.

### FIELD

Embodiments described herein relate generally to an image forming apparatus disposed in a workplace.

### BACKGROUND

Conventionally, there is known an image forming apparatus having various functions. One of the various functions is a direct print function. The direct print function is a function of displaying, in a selectable manner, files in an external device (USB memory, digital camera, smartphone, etc.) that is connected to the image forming apparatus, and directly printing a file selected by a user, without through an intermediate device (computer).

### BRIEF DESCRIPTION OF THE DRAWINGS

FIG. 1 is a diagram illustrating a configuration example of a system including an image forming apparatus according to an embodiment.

FIG. 2 is a diagram illustrating a configuration example of the image forming apparatus according to the embodiment.

FIG. 3 is a diagram illustrating an example of a USB direct print screen that is displayed on a display of the image forming apparatus according to the embodiment.

FIG. 4 is a diagram illustrating an example of direct print in the image forming apparatus according to the embodiment.

FIG. 5 is a diagram illustrating a correspondence relationship between file formats and extensions of conversion source files and conversion target files in file format conversion.

FIG. 6 is a diagram illustrating an example of an MFP user information management table.

FIG. 7 is a diagram illustrating an example of a correlation table between MFP users and cloud users.

FIG. 8 is a diagram illustrating an example of a cloud user management table that is managed in a cloud server.

FIG. 9 is a diagram illustrating an example of a sequence of acquiring an access token of the cloud server.

FIG. 10A is a diagram illustrating a beginning part of an example of a sequence of executing direct print of a file in a USB memory.

FIG. 10B is a diagram illustrating a part following FIG. 10A of the example of the sequence of executing direct print of the file in the USB memory.

FIG. 10C is a diagram illustrating a part following FIG. 10B of the example of the sequence of executing direct print of the file in the USB memory.

### DETAILED DESCRIPTION

An image forming apparatus according to an embodiment includes a storage device and a processor. The storage device stores a direct print app that executes the direct print function, and a conversion app that uses a file format conversion function that a cloud server provides. The processor is configured to execute the direct print app and the conversion app. The processor is configured to execute the direct print app to provide to a user a selection environment for selecting a print target file from the files in the external device. The processor is configured to execute the conversion app to request the cloud server to execute file format conversion for converting a file format of the print target file selected through the selection environment into an applicable file format to which the direct print function is applicable, receive a post-conversion file after the file format conversion from the cloud server, and print the post-conversion file.

Hereinafter, embodiments are described with reference to the accompanying drawings.

### Image Forming System

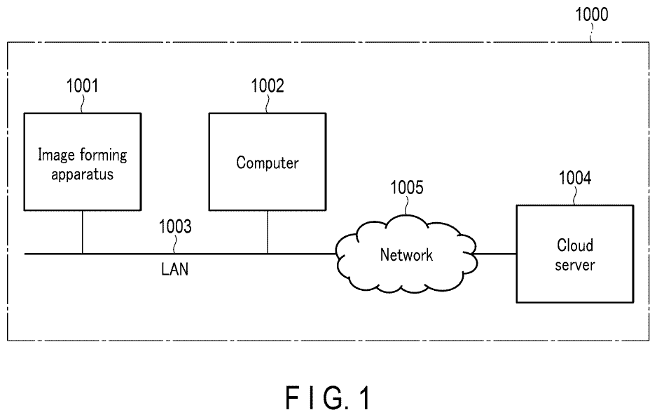

To begin with, referring to FIG. 1, an image forming system 1000 including an image forming apparatus 1001 according to an embodiment is described. FIG. 1 is a diagram illustrating a configuration example of the image forming system 1000 including the image forming apparatus 1001 according to the embodiment.

The image forming system 1000 includes the image forming apparatus 1001, a personal computer 1002, a LAN (Local Area Network) 1003, a could server 1004, and a network 1005.

The image forming apparatus 1001 and the personal computer 1002 are connected to the LAN 1003, and can communicate with each other through the LAN 1003. In addition, the image forming apparatus 1001 and the personal computer 1002 can communicate with the cloud server 1004 through the network 1005.

The image forming apparatus 1001 is, for example, a multifunction peripheral (MFP) having various functions. Thus, hereinafter, in some cases, the image forming apparatus 1001 is described simply as “MFP”. Specifically, the term “MFP” means the image forming apparatus 1001. In addition, the various functions of the image forming apparatus 1001 are also referred to as “MFP functions”.

The image forming apparatus 1001 includes a print function, a scan function, a copy function, a fax function, and the like. The print function is a function of printing an image on a paper sheet. The scan function is a function of scanning an image from a document or the like. The copy function is a function of printing an image that is scanned from a document or the like by using the scan function on a paper sheet by using the print function. The fax function is, for example, a function of transmitting an image that is scanned from a document or the like by using the scan function to the outside, or printing an image that is received from the outside on a paper sheet by using the print function.

The personal computer 1002 is used for, for example, editing of an MFP user information management table that the image forming apparatus 1001 includes, and a cloud user management table that the cloud server 1004 includes.

The cloud server 1004 provides a service of file format conversion. For example, the cloud server 1004 receives a file that cannot be printed by the image forming apparatus 1001, converts the file into a file that can be printed by the image forming apparatus 1001, and returns the file to the image forming apparatus 1001. In one example, the cloud server 1004 converts a Word file, an Excel file, a PowerPoint file, or the like, which is received from the image forming apparatus 1001, into a PDF file, and returns the PDF file to the image forming apparatus 1001.

### Image Forming Apparatus

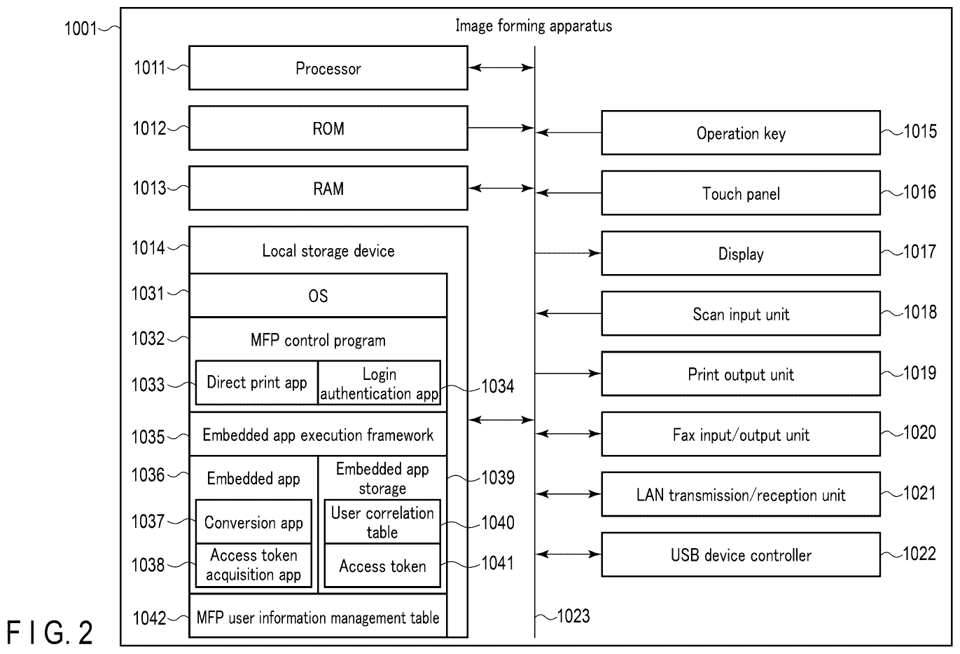

Next, referring to FIG. 2, the image forming apparatus 1001 according to the embodiment is described. FIG. 2 is a diagram schematically illustrating a configuration example of the image forming apparatus 1001 according to the embodiment.

The image forming apparatus 1001 includes a processor 1011, a read-only memory (ROM) 1012, a random access memory (RAM) 1013, a local storage device 1014, an operation key 1015, a touch panel 1016, a display 1017, a scan input unit 1018, a print output unit 1019, a fax input/output unit 1020, a LAN transmission/reception unit 1021, a USB device controller 1022, and a system bus 1023.

The processor 1011 is an arithmetic element that executes an arithmetic process. The processor 1011 controls the image forming apparatus 1001 in accordance with a software program stored in the ROM 1012 or the local storage device 1014. The processor 1011 includes, for example, a central processing unit (CPU), a graphical processing unit (GPU), or the like.

The ROM 1012 is a nonvolatile memory that constitutes a part of a main memory. The ROM 1012 non-transitorily stores a start program that is necessary for starting the image forming apparatus 1001. The ROM 1012 is composed of, for example, an erasable programmable read-only memory (EPROM), and stores various setting data at a start time, in addition to the start program.

The RAM 1013 is a volatile memory that constitutes a part of the main memory. The RAM 1013 temporarily stores a program that is necessary for the processing of the processor 1011, and data that is necessary for the execution of the program. The RAM 1013 functions as a working memory of the processor 1011.

The local storage device 1014 is a nonvolatile memory such as a hard disk drive (HDD) or a solid state drive (SSD). The local storage device 1014 non-transitorily stores a program that the processor 1011 executes, and data that is necessary for the execution of the program. Hereinafter, the program and the data necessary for the execution of the program are comprehensively referred to simply as “program”. In other words, the program includes the data necessary for the execution of the program. A program stored in the local storage device 1014 will be described later.

The operation key 1015 is an input device that accepts an instruction from the user. For example, the operation key 1015 includes a plurality of push keys allocated to various functions, and accepts an instruction from the user through an operation of a push key.

The touch panel 1016 is an input device that accepts an instruction from the user, and accepts an instruction from the user through a touch operation by a finger or a touch pen.

The display 1017 is an output device that presents information to the user and is, to be more specific, a display device that presents information to the user by display. For example, the display 1017 is composed of a liquid crystal display, an organic EL display, or the like.

For example, the touch panel 1016 is laid over the display 1017, and the display function of the display 1017 and the input function of the touch panel 1016 are combined in use. The touch panel 1016 and the display 1017 constitute an input/output device.

The scan input unit 1018 is a device that executes the scan function, and scans an image from a document. The scan input unit 1018 includes, for example, a document glass and a scan module. The scan module scans an image from a document placed on the document glass, or from a document that is fed to the document glass by a document feed device. The scan module radiates illumination light on a document that is a scan target, receives reflective light by an image sensor, and converts the received light into a digital signal. Thereby, the scan module scans an image from the document.

The print output unit 1019 is a device that executes the print function, and prints an image of data on a paper sheet that is conveyed by a sheet convey device, based on print data that is supplied. The print data is, for example, image data that is scanned from the document by the scan input unit 1018. Alternatively, the print data is, for example, image data that is transmitted from an external apparatus other than the image forming apparatus 1001, and is received by the fax input/output unit 1020. Alternatively, the print data is data (file) stored in an external device that is connected to the image forming apparatus 1001.

For example, the print output unit 1019 prints an image on a paper sheet by forming a toner image on a transfer belt and transferring the toner image onto the paper sheet. Alternatively, the print output unit 1019 prints an image on a paper sheet by jetting ink on the paper sheet by an ink jet head. Aside from these methods, the print output unit 1019 may print an image on a paper sheet by other methods.

The fax input/output unit 1020 is a device that executes the fax function. For example, the fax input/output unit 1020 transmits image data scanned by the scan input unit 1018 to an external apparatus or a cloud through a telephone line, and receives image data, which is to be printed by the print output unit 1019, from an external apparatus or a cloud.

The LAN transmission/reception unit 1021 executes communication with an external apparatus or a cloud through a local area network (LAN). The LAN may be constituted by wire, or may be constituted wirelessly. For example, the LAN transmission/reception unit 1021 transmits image data scanned by the scan input unit 1018 to an external apparatus or a cloud, and receives image data, which is to be printed by the print output unit 1019, from an external apparatus or a cloud.

The USB device controller 1022 is a device including a USB port, and controls an external device connected to the USB port. Such external devices include a USB memory, a digital camera, a smartphone, and the like. For example, the USB device controller 1022 reads, from an external device, data (file) that is to be printed by the print output unit 1019, and writes, in the external device, image data (file) that is scanned by the scan input unit 1018.

The system bus 1023 is a communication path between the processor 1011, ROM 1012, RAM 1013, local storage device 1014, operation key 1015, touch panel 1016, display 1017, scan input unit 1018, print output unit 1019, fax input/output unit 1020, LAN transmission/reception unit 1021, and USB device controller 1022. The processor 1011, ROM 1012, RAM 1013, local storage device 1014, operation key 1015, touch panel 1016, display 1017, scan input unit 1018, print output unit 1019, fax input/output unit 1020, LAN transmission/reception unit 1021, and USB device controller 1022 can transmit and receive information, data, control signals, instructions, responses, and the like through the system bus 1023.

The processor 1011, ROM 1012, RAM 1013, and local storage device 1014 constitute a computer that controls the image forming apparatus 1001.

An operating system (OS) 1031, an MFP control program 1032, an embedded app execution framework 1035, an embedded app 1036 and an embedded app storage 1039, and an MFP user information management table 1042 are installed in the local storage device 1014.

Here, “app” is an abbreviation of an application, and means an application. In addition, an application means a software program that achieves a specific work or purpose.

The operating system 1031 is system software, and provides an operational base of an app, i.e., an application.

The MFP control program 1032 includes programs that execute various functions of the image forming apparatus 1001. In addition, the MFP control program 1032 includes various files, setting information and the like, which are necessary for the execution of the programs.

For example, the MFP control program 1032 includes a scan app, a print app, a fax transmission app, and the like. The scan app executes the scan function by controlling the scan input unit 1018. The print app executes the print function by controlling the print output unit 1019. The fax transmission app executes the fax function by controlling the fax input/output unit 1020.

The MFP control program 1032 also includes a direct print app 1033. The direct print app 1033 is a software program for printing a file in an external device that is connected to the USB device controller 1022, without through an intermediate device such as a computer. The direct print app 1033 displays a list of files in the external device on a USB direct print screen, accepts a selection of a print target file from the list of the files through the USB direct print screen, and instructs the print output unit 1019 to print a print target file that is selected on the USB direct print screen.

The MFP control program 1032 also includes a login authentication app 1034. The login authentication app 1034 is a software program for authenticating a user that logs in on the image forming apparatus 1001. The login authentication app 1034 collates user information, which is input to a login screen, with the MFP user information management table 1042, and permits login if the user information is proper.

The embedded app 1036 includes software programs that link with the various functions of the image forming apparatus 1001 and execute other functions. The embedded app storage 1039 is metadata of the embedded app 1036, and includes various files, setting information, and the like that are necessary for the execution of the embedded app 1036.

For example, the embedded app 1036 includes a cloud transfer app, an E-mail transmission app, and the like. The cloud transfer app controls the LAN transmission/reception unit 1021, and executes cloud transfer of processing target data of a linkage source app that links with the cloud transfer app. The E-mail app controls the LAN transmission/reception unit 1021, and executes E-mail transmission of processing target data of a linkage source app that links with the E-mail app.

The embedded app 1036 also includes a conversion app 1037. The conversion app 1037 is a software program that links with the direct print app 1033 and uses a service of file format conversion, which is provided by the cloud server 1004. The conversion app 1037 sends to the cloud server 1004 a conversion source file to which the print function of the image forming apparatus 1001 is not applicable, requests the cloud server 1004 to convert the conversion source file into a conversion target file to which the print function of the image forming apparatus 1001 is applicable, and receives the conversion target file from the cloud server 1004.

The embedded app 1036 includes an access token acquisition app 1038. The access token acquisition app 1038 is a software program for acquiring an access token that is authentication information for accessing the cloud server 1004. The access token acquisition app 1038 requests the cloud server 1004 to issue the access token, and acquires the access token from the cloud server 1004.

The embedded app storage 1039 stores a user correlation table 1040 and an access token 1041. The user correlation table 1040 includes, in a table format, information that correlates an MFP user with a cloud user. The access token 1041 is authentication information for accessing the cloud server 1004, the authentication information being acquired by the access token acquisition app 1038.

The MFP user information management table 1042 includes, in a table format, management information of users of the image forming apparatus 1001. For example, the MFP user information management table 1042 includes, in regard to each of the users, identification information, information of assignment of execution rights of the MFP function, and the like. The identification information includes, for example, a user ID, a password, and the like.

The embedded app execution framework 1035 controls the embedded app 1036, based on the information of the MFP user information management table 1042.

The programs installed in the local storage device 1014 are provided to the image forming apparatus 1001, for example, through a non-transitory computer-readable storage medium. Alternatively, the programs may be stored in a server on a network, and may be provided to the image forming apparatus 1001 by being downloaded.

For example, at a time of starting the computer, the processor 1011 executes the start program in the ROM 1012, and starts the OS 1031. Under the control by the OS 1031, the processor 1011 monitors the input of instructions, the connection of external devices, and the like. In addition, under the control by the OS 1031, the processor 1011 sets a program area and a data area in the RAM 1013.

For example, by loading in the RAM 1013 the various function control applications stored in the local storage device 1014 and executing the various function control applications, the processor 1011 controls the devices of the image forming apparatus 1001 and controls the entirety of the image forming apparatus 1001.

In addition, for example, by loading in the RAM 1013 the various embedded apps stored in the local storage device 1014 and executing the various embedded apps, the processor 1011 executes various functions of the image forming apparatus 1001, for instance, the print function, direct print function, scan function, copy function, fax function, and the like.

### Direct Print

Hereinafter, the direct print is described. Here, an example is described in which a USB memory is connected as an external device to the USB device controller 1022 of the image forming apparatus 1001.

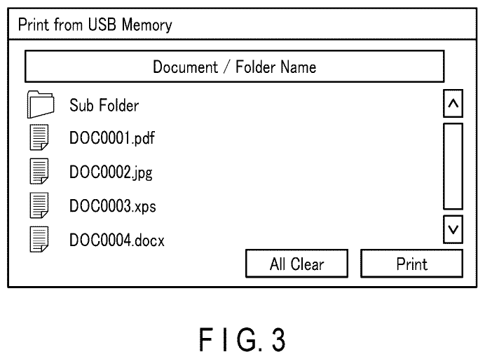

If the USB memory is connected to the USB device controller 1022 of the image forming apparatus 1001, and the direct print function is selected, a USB direct print screen is displayed on the display 1017 of the image forming apparatus 1001. FIG. 3 illustrates an example of the USB direct print screen that is displayed on the display 1017 of the image forming apparatus 1001. The USB direct print screen displays lists of folders and files in the USB memory. Each of the folders is developable, and each of the files is selectable. Touching a “Print” icon instructs the execution of the print of the selected file.

For example, the print function of the image forming apparatus 1001 is applicable to files of major file formats and can print files of applicable file formats, but is not applicable to files of novel file formats and cannot print files of nonapplicable file formats. The applicable file formats include “.PDF”, “.JPEG”, “.XPS”, “.PRN”, “.PS”, and the like. In addition, the nonapplicable file formats include “.docx”, “.xlsx”, “.pptx”, “.psd”, “.ai”, and the like.

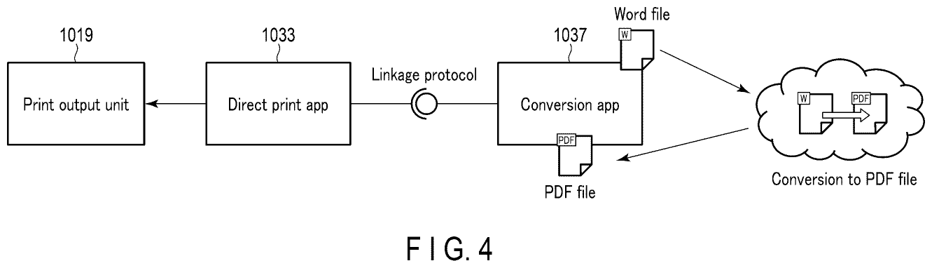

FIG. 4 is a diagram illustrating an example of the direct print in the image forming apparatus 1001. The direct print app 1033 of the MFP control program 1032 determines whether the print target file (the file selected on the operation screen of FIG. 3) is a file of an applicable file format.

Specifically, as will be described later, the direct print app 1033 of the MFP control program 1032 sends a file format conversion request to the embedded app execution framework 1035, and the embedded app execution framework 1035 determines the file format of the print target file. However, here, for the purpose of convenience, the description is given on the assumption that the direct print app 1033 determines the file format of the print target file.

As a result of the determination, if the print target file is a file of an applicable file format, the direct print app 1033 outputs the file as such to the print output unit 1019. The print output unit 1019 prints the received print target file of the applicable file format.

On the other hand, if the print target file is a file of a nonapplicable file format, the direct print app 1033 links with the conversion app 1037 of the embedded app 1036, and uses the service of file format conversion that is provided by the cloud server 1004.

The direct print app 1033 outputs the print target file to the conversion app 1037. The conversion app 1037 transmits the print target file to the cloud server 1004, and requests the cloud server 1004 to convert the print target file into a file of an applicable file format. Responding to the request, the cloud server 1004 converts the print target file into a file of an applicable file format, and returns the file of the applicable file format to the conversion app 1037. The conversion app 1037 outputs the received print target file after the file format conversion (post-conversion file) to the direct print app 1033. The direct print app 1033 outputs the received print target file of the applicable file format to the print output unit 1019. The print output unit 1019 prints the received print target file of the applicable file format.

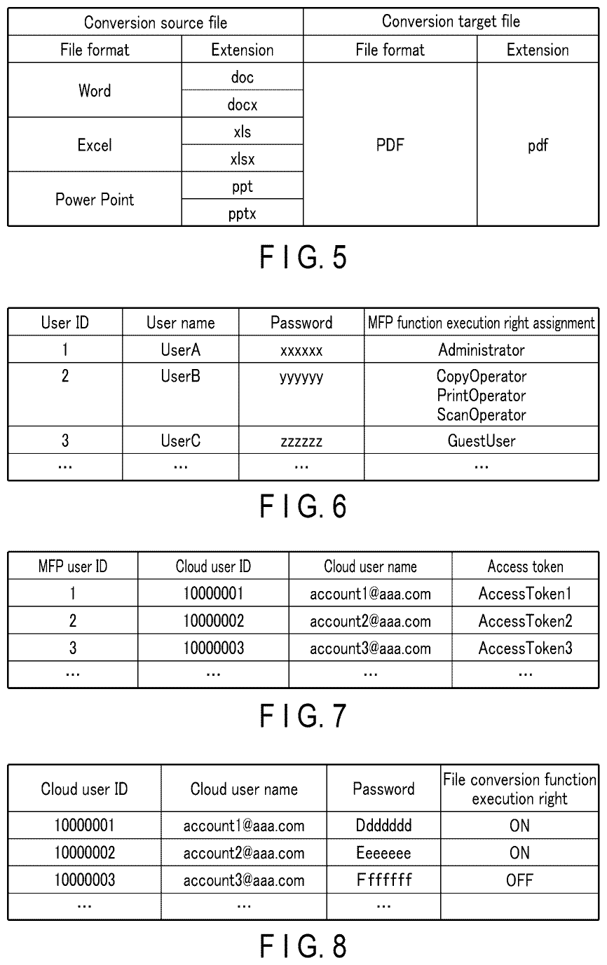

FIG. 5 illustrates an example of the file format conversion provided by the cloud server 1004. FIG. 5 is a diagram illustrating a correspondence relationship between file formats and extensions of conversion source files and conversion target files in the file format conversion. FIG. 5 illustrates, by way of example, file format conversion from an Office-related file into a PDF file.

Since the conversion app 1037, which uses the file format conversion service provided by the cloud server 1004 in linkage with the direct print app 1033, is installed, applicable file formats that are printable are extended. Thus, on the USB direct print screen of FIG. 3, a Word-format file (docx file) is also displayed in the list as a file of a print target candidate.

### MFP User Information Management Table

Next, referring to FIG. 6, an example of the MFP user information management table is described. FIG. 6 is a diagram illustrating an example of the MFP user information management table 1042.

The MFP user information management table 1042 includes information used for user authentication of the image forming apparatus 1001 in a table format. The MFP user information management table 1042 includes column captions of a user ID, a user name, a password, and an MFP function execution right assignment. The user ID is an identification code of a user, the user name is the name of the user, the password is a secret character string, and the MFP function execution right assignment is information of an execution right of an MFP function that is assigned to the user.

The MFP user information management table 1042 is managed by an administrator of the image forming apparatus 1001, and is referred to at a time when the user logs in on the image forming apparatus 1001. For example, the administrator of the image forming apparatus 1001 accesses the image forming apparatus 1001 from the personal computer 1002 by using a browser function, and performs management (edit, update, etc.) of the MFP user information management table 1042.

### User Correlation Table

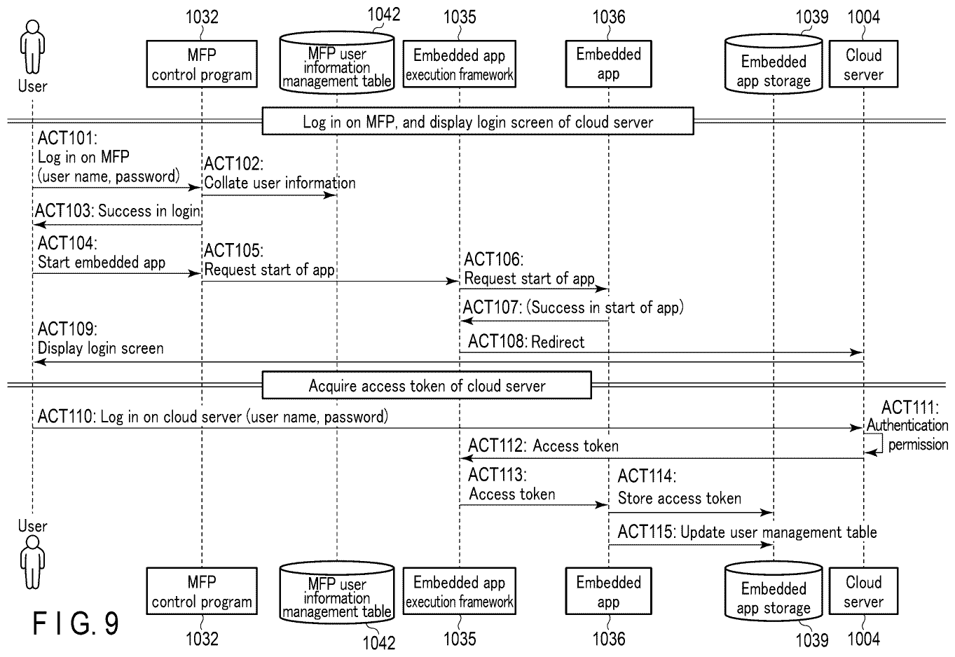

Next, referring to FIG. 7, a description is given of an example of the user correlation table including information of a correlation between MFP users and cloud users. FIG. 7 is a diagram illustrating an example of the user correlation table 1040 between the MFP users and the cloud users.

The user correlation table 1040 includes, in a table format, information of the correlation between the MFP users and the cloud users, and information used for cloud user authentication of the cloud server 1004. The user correlation table 1040 includes column captions of an MFP user ID, a cloud user ID, a cloud user name, and an access token. The MFP user ID is an identification code of an MFP user, the cloud user ID is an identification code of a cloud user, the cloud user name is the name of the cloud user, and the access token is authentication information that is issued to the cloud user.

The user correlation table 1040 is stored in the embedded app storage 1039 that can be accessed by the embedded app 1036. The conversion app 1037 of the embedded app 1036 refers to this table information at a time of using the service of the cloud server 1004. The user correlation table 1040 is managed by the conversion app 1037.

### Cloud User Management Table

Next, referring to FIG. 8, an example of the cloud user management table is described. FIG. 8 is a diagram illustrating an example of the cloud user management table that is managed in the cloud server 1004 of FIG. 1.

The cloud user management table includes information used for user management in the cloud server 1004 in a table format. The cloud user management table includes column captions of a cloud user ID, a cloud user name, a password, and a file conversion function execution right. The cloud user ID is an identification code of a cloud user, the cloud user name is the name of the cloud user, the password is a secret character string, and the file conversion function execution right is information of presence/absence of an execution right of the file conversion function assigned to the cloud user. The cloud user management table is referred to, at a time when the cloud user logs in on the cloud server 1004 or when the cloud user executes the file conversion function.

The cloud user management table is managed by an administrator of the cloud server 1004 of FIG. 1. In addition, the administrator of the image forming apparatus 1001 accesses the cloud server 1004 from the personal computer 1002 of FIG. 1 by using the browser function, and requests a change, or the like, of the cloud user management table.

### Access Token Acquisition Sequence

Next, referring to FIG. 9, a description is given of an example of a sequence of acquiring the access token of the cloud server. FIG. 9 is a diagram illustrating an example of the sequence of acquiring the access token of the cloud server 1004.

To start with, the user inputs a user name and a password, which are user information, and logs in on the image forming apparatus 1001 (ACT 101).

Next, the MFP control program 1032 (login authentication app 1034) collates the user name and password with the MFP user information management table 1042 (ACT 102).

If the user information exists and the collation is successful, the MFP control program 1032 (login authentication app 1034) permits login, and displays the success in login on the display 1017 (ACT 103).

Next, the user starts the embedded app 1036 (access token acquisition app 1038) by operating the touch panel 1016 (ACT 104).

Then, upon accepting the operation of the touch panel 1016, the MFP control program 1032 requests the embedded app execution framework 1035 to start the embedded app 1036 (access token acquisition app 1038) (ACT 105).

Next, the embedded app execution framework 1035 starts the embedded app 1036 (access token acquisition app 1038) (ACT 106).

After successfully starting the embedded app 1036 (access token acquisition app 1038) (ACT 107), the embedded app execution framework 1035 executes URL redirect (ACT 108), and displays a login screen of the cloud server 1004 on the display 1017 (ACT 109).

Next, the user inputs the cloud user name and the password, which are the cloud user information, to the login screen of the cloud server 1004, and logs in on the cloud server 1004 (ACT 110).

The cloud server 1004 collates the cloud user name and password with the cloud user management table, and executes cloud user authentication (ACT 111).

If the authentication is successful, the cloud server 1004 issues an access token (ACT 112), and then a callback URL of the embedded app 1036 is called through the embedded app execution framework 1035, and the access token is delivered to the embedded app (ACT 113).

The embedded app 1036 stores the received access token 1041 in the embedded app storage 1039 (ACT 114).

Thereafter, the embedded app updates the user correlation table 1040 in the embedded app storage 1039 (ACT 115).

### Direct Print Sequence

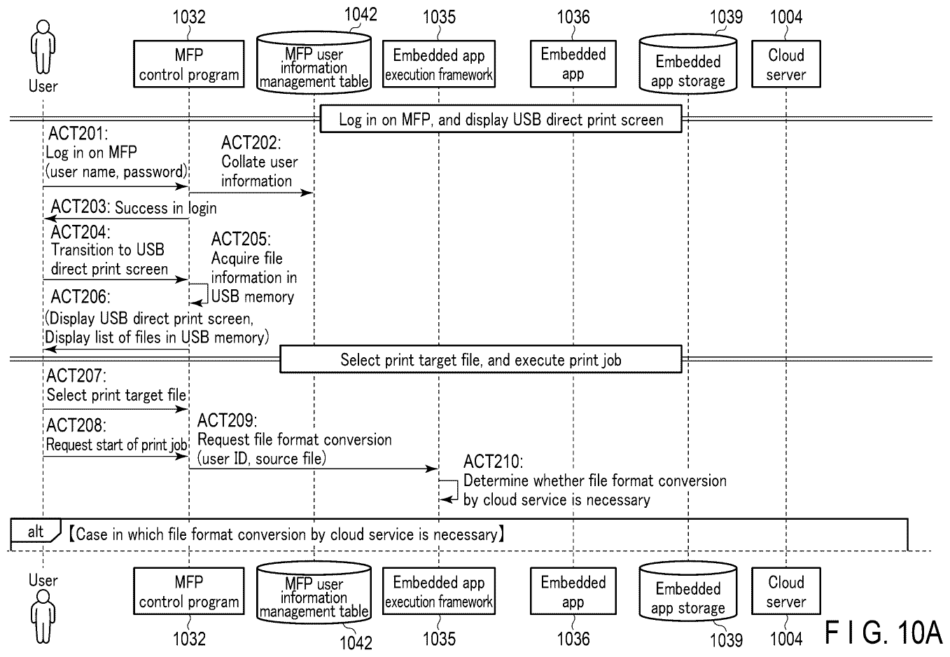

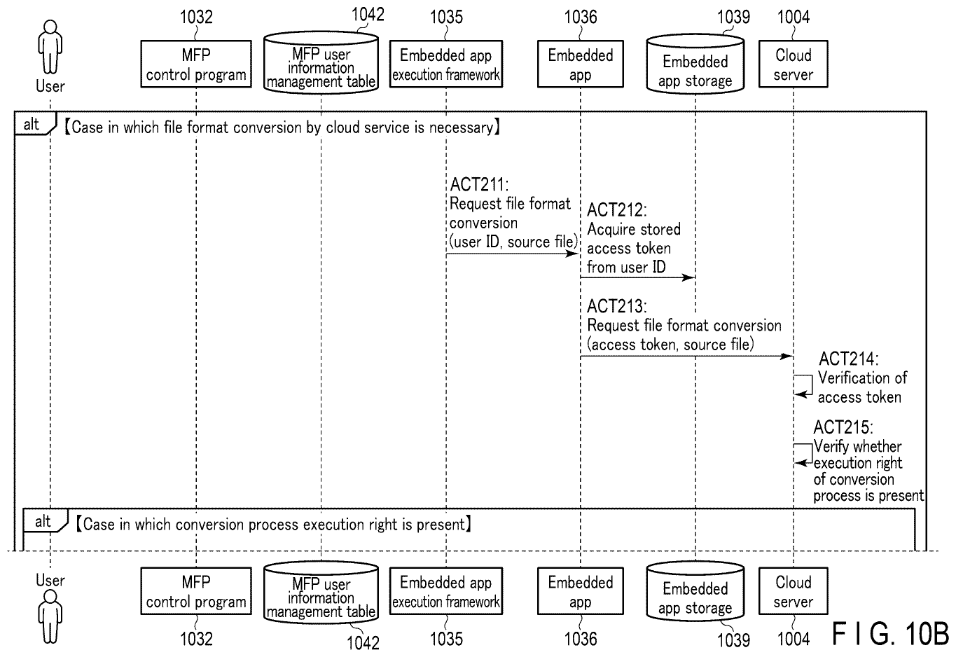

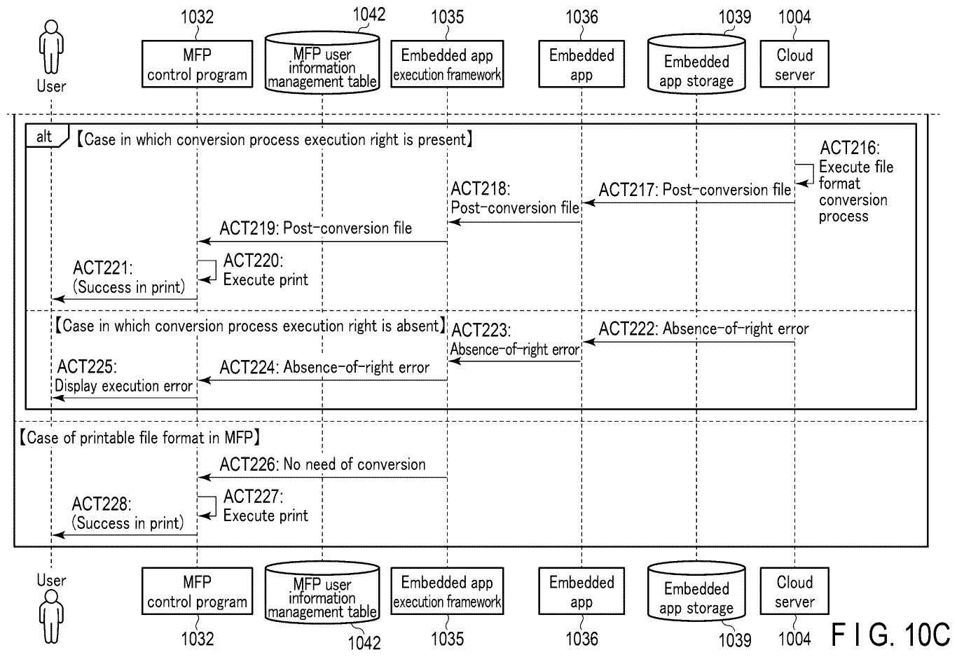

Next, referring to FIG. 10A to FIG. 10C, a description is given of an example of a sequence of executing direct print of a file in a USB memory. FIG. 10A to FIG. 10C are diagrams illustrating a sequence of executing direct print of a file in the USB memory. FIG. 10A illustrates a beginning part of the sequence of the direct print, FIG. 10B illustrates a part following FIG. 10A of the sequence of the direct print, and FIG. 10C illustrates a part following FIG. 10B of the sequence of the direct print.

Before the execution of the sequence of FIG. 10A to FIG. 10C, it is necessary to acquire the access token 1041 of the cloud server 1004, and to store the access token 1041 in the embedded app storage 1039. Thus, the sequence of FIG. 10A to FIG. 10C is executed after the access token of the cloud server 1004 is acquired by the sequence of FIG. 9.

To start with, the user inputs the user name and the password which are the user information, and logs in on the image forming apparatus 1001 (ACT 201).

Next, the MFP control program 1032 (login authentication app 1034) collates the user name and password with the MFP user information management table 1042 (ACT 202).

If the user information exists and the collation is successful, the MFP control program 1032 (login authentication app 1034) permits login, and displays the success in login on the display 1017 (ACT 203).

Next, the user connects a USB memory to the USB device controller 1022, and executes a transition to a USB direct print screen by operating the touch panel 1016 (ACT 204). The order of the connection of the USB memory and the transition to the USB direct print screen may be reversed.

Next, the MFP control program 1032 (direct print app 1033) acquires file information in the USB memory connected to the USB device controller 1022 (ACT 205), and displays a list of files in the USB memory on the USB direct print screen (ACT 206).

Subsequently, the user selects one or more print target files from the list of the files in the USB memory, which is displayed on the USB direct print screen (ACT 207).

Next, the user requests print job execution of the print target file (ACT 208).

The MFP control program 1032 (direct print app 1033) issues a file format conversion request to the embedded app execution framework 1035 (ACT 209).

The embedded app execution framework 1035 checks the file format of each of print target files, and determines whether the file format is a printable file format in the image forming apparatus 1001, that is, whether the file format conversion by the cloud server 1004 is necessary (ACT 210).

If the file format conversion by the cloud server 1004 is necessary, the embedded app execution framework 1035 issues a file format conversion request to the embedded app 1036 (conversion app 1037) (ACT 211).

If the file format conversion is necessary, the embedded app 1036 (conversion app 1037) operates in linkage with the direct print app 1033. The embedded app 1036 (conversion app 1037) refers to the user correlation table 1040, and acquires, from an MFP user ID, the access token that is issued to the cloud user correlated with the MFP user ID (ACT 212).

Next, the embedded app 1036 (conversion app 1037) transmits the access token and the conversion source file to the cloud server 1004, and issues a file format conversion request to the cloud server 1004 (ACT 213).

The cloud server 1004 verifies the access token received from the embedded app 1036 (conversion app 1037) (ACT 214).

If the access token is invalid, for example, if the valid period of the access token expired, the cloud server 1004 returns a token invalid error message to the embedded app 1036 (conversion app 1037). The embedded app 1036 (conversion app 1037) delivers the received token invalid error message to the embedded app execution framework 1035, the embedded app execution framework 1035 delivers the received token invalid error message to the MFP control program 1032, and the MFP control program 1032 displays the token invalid error message on the display 1017.

On the other hand, if the access token is valid, for example, if the valid period of the access token has not expired, the cloud server 1004 specifies the cloud user from the access token, and verifies whether the cloud user has an execution right of the file format conversion process (ACT 215).

If the cloud user has the execution right, the cloud server 1004 executes the file format conversion process (ACT 216), and transmits the print target file after the file format conversion (post-conversion file) to the embedded app 1036 (conversion app 1037) (ACT 217).

The embedded app 1036 (conversion app 1037) delivers the post-conversion file to the MFP control program 1032 (direct print app 1033) through the embedded app execution framework 1035 (ACT 218, ACT 219).

The MFP control program 1032 (direct print app 1033) outputs the received post-conversion file to the print output unit 1019, and the print output unit 1019 executes a print job on the received post-conversion file (ACT 220).

If the print is successful, the MFP control program 1032 displays the success of the print on the display 1017 (ACT 221). On the other hand, if the print is unsuccessful, the MFP control program 1032 displays the unsuccess of the print on the display 1017.

Furthermore, as a result of the verification of the execution right (ACT 215), if the cloud user does not have the execution right of the file format conversion process, the cloud server 1004 returns an absence-of-right error message to the embedded app 1036 (conversion app 1037) (ACT 222).

The embedded app 1036 (conversion app 1037) delivers the received absence-of-right error message to the embedded app execution framework 1035 (ACT 223), the embedded app execution framework 1035 delivers the received absence-of-right error message to the MFP control program 1032 (ACT 224), and the MFP control program 1032 displays an execution error message (absence-of-right error message) on the display 1017 (ACT 225).

Besides, as a result of the determination as to whether the file format conversion by the cloud server 1004 is necessary (ACT 210), if the file format conversion is unnecessary, that is, if the file format is the printable file format in the image forming apparatus 1001, the embedded app execution framework 1035 delivers the unconverted print target file to the MFP control program 1032 (direct print app 1033) (ACT 226).

The MFP control program 1032 (direct print app 1033) outputs the received unconverted print target file to the print output unit 1019, and the print output unit 1019 executes a print job on the unconverted print target file (ACT 227).

If the print is successful, the MFP control program 1032 displays the success of the print on the display 1017 (ACT 228). On the other hand, if the print is unsuccessful, the MFP control program 1032 displays the unsuccess of the print on the display 1017.

### Advantageous Effects

According to the embodiment, printable file formats of the direct print function can easily be extended without the need to re-create or install a system ROM of the image forming apparatus 1001. Specifically, it is possible to provide an image forming apparatus including a direct print function that is applicable to a novel file format without the need to update a control program, and to provide a control program of the image forming apparatus.

The accounts of the image forming apparatus 1001 and the accounts of the cloud server 1004 are correlated and managed in regard to each of users of the image forming apparatus 1001. Thus, the use of the file format conversion function of the cloud server 1004 can be limited to a proper user having an execution right of the file format conversion function. Thereby, the improper use of the cloud server 1004 is restricted, and the use of the cloud server 1004 is limited to the proper use.

The program according to the present embodiment may be transferred in a state in which the program is stored in an electronic device, or may be transferred in a state in which the program is not stored in an electronic device. In the case of the latter, the program may be transferred through a network, or may be transferred in a state in which the program is stored in a storage medium. The storage medium is a non-transitory tangible medium. The storage medium is a computer-readable medium. The storage medium may be in any form, if the storage medium is a medium that can store a program, such as a CD-ROM or a memory card, and that can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus including a direct print function of directly printing a file in an external device, the image forming apparatus comprising:
a storage device storing a direct print app that executes the direct print function, and a conversion app that uses a file format conversion function that a cloud server provides; and
a processor configured to execute the direct print app and the conversion app,
the processor being configured to:
execute the direct print app to provide to a user a selection environment for selecting a print target file from the files in the external device; and
execute the conversion app to request the cloud server to execute file format conversion for converting a file format of the print target file selected via the selection environment into an applicable file format to which the direct print function is applicable, receive a post-conversion file after the file format conversion from the cloud server, and print the post-conversion file.

2. The image forming apparatus of claim 1, wherein
the processor is configured to display a list of the files in the external device, and accept a selection of the print target file from the list of the files, via the selection environment.

3. The image forming apparatus of claim 1, wherein
the storage device stores a login authentication app for authenticating the user that logs in on the image forming apparatus, and first user management information relating to the image forming apparatus, and
the processor is configured to execute the login authentication app to execute login authentication for the image forming apparatus by using the first user management information.

4. The image forming apparatus of claim 3, wherein:
the storage device stores an access token acquisition app for acquiring an access token for accessing the cloud server, and second user management information relating to the cloud server, and
after the login authentication is successful, the processor is configured to execute the access token acquisition app to:
request the access token of the logged-in user to the cloud server;
acquire the access token from the cloud server; and
store the access token of the user in the second user management information.

5. The image forming apparatus of claim 4, wherein
after the login authentication is successful, the processor is configured to execute the direct print app to:
provide the selection environment to the user; and
determine whether the file format conversion by the cloud server is necessary for the print target file selected via the selection environment.

6. The image forming apparatus of claim 5, wherein
the processor is configured to determine whether the file format conversion is necessary, based on a file format of the print target file.

7. The image forming apparatus of claim 6, wherein
the processor is configured to:
determine whether the print target file is a file of the applicable file format;
determine that the file format conversion is unnecessary, if the print target file is a file of the applicable file format; and
determine that the file format conversion is necessary, if the print target file is a file of a nonapplicable file format.

8. The image forming apparatus of claim 5, wherein
the processor is configured to:
execute the direct print app to print the print target file from, in a case where the file format conversion is unnecessary; and
execute the conversion app, in a case where the file format conversion is unnecessary, to acquire the access token of the user from the second user management information, transmit the access token and the print target file to the cloud server, and request the cloud server to execute the file format conversion.

9. The image forming apparatus of claim 8, wherein
the processor is configured to receive a token invalid error message that is transmitted from the cloud server, and display the token invalid error message, in a case where the access token is invalid as a result of verification by the cloud server as to whether the access token is valid.

10. The image forming apparatus of claim 9, wherein,
in a case where the access token is valid as a result of the verification by the cloud server as to whether the access token is valid,
the processor is configured to:
acquire the post-conversion file after the execution of the file format conversion on the print target file by the cloud server, and print the post-conversion file, in a case where the user has an execution right of the file format conversion as a result of verification based on the access token by the cloud server as to whether the user has the execution right of the file format conversion; and
receive an absence-of-right error message that is transmitted from the cloud server, and display the absence-of-right error message, in a case where the user does not have the execution right of the file format conversion as a result of the verification based on the access token by the cloud server as to whether the user has the execution right of the file format conversion.

11. A non-transitory computer-readable storage medium storing a control program of an image forming apparatus including a direct print function of directly printing a file in an external device,
the image forming apparatus comprising: a storage device storing a direct print app that executes the direct print function, and a conversion app that uses a file format conversion function that a cloud server provides; and a processor configured to execute the direct print app and the conversion app,
the control program causing the processor to:
execute the direct print app to provide to a user a selection environment for selecting a print target file from the files in the external device; and
execute the conversion app to request the cloud server to execute file format conversion for converting a file format of the print target file selected via the selection environment into an applicable file format to which the direct print function is applicable, receive a post-conversion file after the file format conversion from the cloud server, and print the post-conversion file.

12. The storage medium of claim 11, wherein
the control program causes the processor to display a list of the files in the external device, and accept a selection of the print target file from the list of the files, via the selection environment.

13. The storage medium of claim 11, wherein
the storage device stores a login authentication app for authenticating the user that logs in on the image forming apparatus, and first user management information relating to the image forming apparatus, and
the control program causes the processor to execute the login authentication app to execute login authentication for the image forming apparatus by using the first user management information.

14. The storage medium of claim 13, wherein
the storage device stores an access token acquisition app for acquiring an access token for accessing the cloud server, and second user management information relating to the cloud server, and
after the login authentication is successful, the control program causes the processor to execute the access token acquisition app to:
request the access token of the logged-in user to the cloud server;
acquire the access token from the cloud server; and
store the access token of the user in the second user management information.

15. The storage medium of claim 14, wherein
after the login authentication is successful, the control program causes the processor to execute the direct print app to:
provide the selection environment to the user; and
determine whether the file format conversion by the cloud server is necessary for the print target file selected via the selection environment.

16. The storage medium of claim 15, wherein
the control program causes the processor to:
determine whether the print target file is a file of the applicable file format;
determine that the file format conversion is unnecessary, if the print target file is a file of the applicable file format; and
determine that the file format conversion is necessary, if the print target file is a file of a nonapplicable file format.

17. The storage medium of claim 15, wherein
the control program causes the processor to:
execute the direct print app to print the print target file from, in a case where the file format conversion is unnecessary; and
execute the conversion app, in a case where the file format conversion is unnecessary, to acquire the access token of the user from the second user management information, transmit the access token and the print target file to the cloud server, and request the cloud server to execute the file format conversion.

18. The storage medium of claim 17, wherein
the control program causes the processor to receive a token invalid error message that is transmitted from the cloud server, and display the token invalid error message, in a case where the access token is invalid as a result of verification by the cloud server as to whether the access token is valid.

19. The storage medium of claim 18, wherein
in a case where the access token is valid as a result of the verification by the cloud server as to whether the access token is valid,
the control program causes the processor to:
acquire the post-conversion file after the execution of the file format conversion on the print target file by the cloud server, and print the post-conversion file, in a case where the user has an execution right of the file format conversion as a result of verification based on the access token by the cloud server as to whether the user has the execution right of the file format conversion; and
receive an absence-of-right error message that is transmitted from the cloud server, and display the absence-of-right error message, in a case where the user does not have the execution right of the file format conversion as a result of the verification based on the access token by the cloud server as to whether the user has the execution right of the file format conversion.

20. A direct print method executed by an image forming apparatus including a direct print function of directly printing a file in an external device, the method comprising:
providing to a user a selection environment for selecting a print target file from the files in the external device; and
requesting the cloud server to execute file format conversion for converting a file format of the print target file selected via the selection environment into an applicable file format to which the direct print function is applicable, receiving a post-conversion file after the file format conversion from the cloud server, and printing the post-conversion file.
